(19) United States
(12) Patent Application Publication
(10) Pub. No.: US 2006/0169039 A1
(43) Pub. Date: Aug. 3, 2006

(54) Fuel density measurement device, system, and method

(75) Inventors: Thomas Zalenski, Burlington, CT (US); Calvin E. Tanck, Southwick, MA (US); Adriano Baglioni, South Windsor, CT (US)

Correspondence Address: WITHROW & TERRANOVA, P.L.L.C., P.O. BOX 1287, CARY, NC, 27512, US

(73) Assignee: VEEDER-ROOT COMPANY, Simsbury, CT (US)

(21) Appl. No.: 11/048,145

(22) Filed: Feb. 1, 2005

(51) Int. Cl. G01F 23/00

(52) U.S. Cl. 73/290 R

(57) ABSTRACT

A fuel tank probe includes a water level float and a fuel level float. A fuel weight sensor is incorporated into the fuel tank probe to report the density of the fuel within the tank. The fuel weight sensor includes a compressible bladder whose shape changes as a function of the density of the fuel. A magnet on the compressible bladder moves in conjunction with the changing shape of the compressible bladder, and allows a fuel column height to be measured. The density of the fuel can be determined from the measured fuel column height.

### FIELD OF THE INVENTION

The present invention relates to a probe used in a fuel storage tank that detects not only the height of the fuel within the storage tank, but also the density of the fuel within the storage tank.

### BACKGROUND OF THE INVENTION

Fueling environments typically store fuel in large underground storage tanks. To comply with environmental laws, rules, and regulations, these storage tanks may be double walled and equipped with various leak detection sensors and inventory reconciliation systems. One popular sensor is sold by Veeder-Root Company of 125 Powder Forest Drive, Simsbury, Conn. 06070 under the name “The MAG Plus Inventory Measurement Probe” (Mag Probe) and, this sensor is typically matched with a tank monitor, such as the TLS-350R also sold by Veeder-Root Company. Such probes measure a height of fuel within the storage tank and may optionally measure a height of water (if present). The measurements are then reported to the tank monitor for usage by the operator of the fueling environment to evaluate fuel inventory and/or detect leaks.

While the United States has many rules and regulations relating to leak monitoring within fueling environments, other locales have additional requirements for fueling environments. For example, Russia and India have seen a rise in fraud at fueling environments, and have consequently taken steps to combat such fraud. Specifically, some fueling environment operators dilute the fuel within storage tanks and sell the diluted fuel to customers. One way in which the diluted fuel is created is through the addition of alcohol to the fuel storage tank. The alcohol allows the water at the bottom of the fueling tank to mix with the fuel, and the diluted mixture is then dispensed as normal through the fuel dispensers. To the extent that the adulterated fuel is not what the customer thinks he is purchasing, the fueling environment has committed fraud.

To combat this fraud, the governments of these countries have mandated that fuel density be measured. If the density is outside of a predetermined allowable range, it may be inferred that the fuel has been adulterated. While these fraudulent activities have not been widely detected in the United States, it is possible that the practice abounds and has not been detected because no one has ever thought to test for the adulteration. It is also possible that the recent rise in gas prices may cause less scrupulous individuals to perpetrate such activities. In such an event, the United States may pass legislation requiring fuel density to be measured and reported. Even if the United States does not pass such legislation in the near future, some fuel distribution companies that operate service stations may find it desirable to monitor the density of their fuel for quality control purposes.

All the devices currently known to be available commercially that are capable of measuring fuel density in a conventional fueling environment fuel storage tank are stand alone peripherals, requiring their own power and interface connections. Furthermore, these devices tend to have a limited range over which fuel density can be measured. Such stand alone peripherals are not desirable as a result of these deficiencies. Thus, there exists a need for an improved fuel density sensor.

### SUMMARY OF THE INVENTION

The present invention is an improvement on a conventional fuel level probe that measures fuel height in a fuel storage tank. Specifically, the present invention adds a fuel weight sensor to the probe shaft of a magnetostrictive probe operating with a typical fuel float. The fuel weight sensor works to measure the weight of a column of fuel positioned above the fuel weight sensor. The height of the fuel float, together with the height of the fuel weight sensor, allows calculation of the volume of the column of fuel. The weight of the column of fuel divided by the volume of the column of fuel results in a density measurement for the column of fuel, from which the density of the fuel in the fuel storage tank may be inferred.

In practice, the fuel weight sensor includes a compressible portion that compresses or decompresses as a function of the weight of the fuel column. The fuel weight sensor also includes a magnet positioned on top of the compressible portion of the sensor. As the compressible portion of the sensor changes shape due to changes in the weight of the column of fuel, the magnet on top of the compressible portion of the sensor moves up and down on the probe shaft of the magnetostrictive probe, and thus the absolute distance between the sensor and the bottom of the probe shaft changes. The position of the magnet of the fuel weight sensor is then detected by the magnetostrictive probe. By comparing the position of the magnet of the fuel weight sensor to a position of the fuel float, a height of the column of fuel may be determined. By comparing the position of the magnet of the fuel weight sensor to a known reference point, the weight of the column of fuel may be determined. Using the height to calculate volume of the column of fuel, the weight may be divided by the volume, and the density derived.

The fuel weight sensor is positioned proximate the bottom of the probe shaft such that it is positioned in the fuel and not in water that may have accumulated within the fuel storage tank. Since the fuel weight sensor is located proximate the bottom of the fuel column, the position of the fuel weight sensor allows measurement of the weight of a column of fuel that spans substantially the entire amount of fuel within the storage tank, which in turns allows calculation of the average density of the entire fuel column in the storage tank, not just a particular portion or section of the fuel column.

The fuel weight sensor reports its measurements to a tank monitor, and the tank monitor may calculate a fuel density. The tank monitor may subsequently report the fuel density to a site controller or point-of-sale (POS) system within the service station environment, which may in turn report the fuel density to an off-site location. Alternatively, the fuel weight sensor may report the measurements and/or a calculated fuel density directly to the off-site location.

A typical magnetostrictive probe that is well suited for modification for use with the present invention includes a probe shaft that extends into a fuel tank and has a first float with a magnet thereon to detect a water level within the tank. This first float is sometimes referred to as a water level float. The probe also has a second float with a magnet thereon to detect a fuel level within the tank. This second float is sometimes referred to as a fuel level float. The probe generates an electric current that travels down a wire in the probe shaft and measures the time required for reflections from the magnets to return to determine the position of the magnets relative the length of the probe shaft. From these measurements, the height of the water and the height of the fuel may be determined readily. A pressure sensor may be positioned in some fuel storage tanks. Some embodiments of the present invention will use this pressure sensor to measure the ambient pressure within the fuel storage tank.

A first exemplary embodiment of the present invention positions the fuel weight sensor proximate the water level float, and may be attached to a top surface of the water level float. The fuel weight sensor includes a bladder whose shape changes as a function of the weight of the column of fuel. The bladder includes a fuel weight magnet whose vertical position on the probe shaft changes as the shape of the bladder changes, and thus the vertical position of the fuel weight magnet relative to the bottom of the probe shaft changes as the shape of the bladder changes. When an electric current is sent down the magnetostrictive probe, and particularly sent down a magnetostrictive wire within the probe, the magnets cause the magnetostrictive wire within the probe shaft to twist. This twisting in turn creates a torsional wave that travels up and down the magnetostrictive material. Each magnet creates its own torsional wave in response to the electric current. In effect, the torsional waves may be thought of as reflections. From these reflections, the height of the water may be determined using the water float, the height of the fuel may be determined using the fuel float, and the height of the fuel weight magnet on the compressible bellows may be determined. From these measurements and a known cross sectional area of the bladder, the volume of the fuel column may be calculated. From the ambient pressure in the fuel tank and the height of the fuel weight magnet relative to the height of the water float, the weight of the fuel column is determined. The density of the fuel is calculated using the weight and volume of the fuel column.

In a first specific embodiment, the bladder of the fuel weight sensor is a sealed bladder shaped like a toroid, and the fuel weight magnet is positioned thereon. This toroid shaped bladder may be positioned on top of the water float. As the weight of the column of fuel changes, the size of the toroid shaped bladder changes, effectively moving the fuel weight magnet relative to the water float. From the weight and volume, the density of the fuel may be determined.

In a second specific embodiment, the bladder of the fuel weight sensor may be shaped like a bellows. This bellows shaped bladder may be positioned on top of the water float. As the weight of the column of fuel changes, the compression of the bellows changes, effectively moving the fuel weight magnet relative to the water float. From the weight and volume, the density of the fuel may be determined. The function of weight to density for the bellows embodiment may be more linear than the same function for the toroid shaped bladder, and thus density may be easier to compute for this embodiment.

In a third embodiment, the bladder of the fuel weight sensor may be a bellows attached to the bottom of the probe shaft and extending to the side thereof. The probe shaft may be plumbed such that the ambient atmosphere in the ullage of the storage tank is fluidly connected to the bellows. In this embodiment, the ambient pressure sensor need not be present, as the bellows already compensates for the ambient pressure within the fuel tank.

Those skilled in the art will appreciate the scope of the present invention, and realize additional aspects thereof after reading the following detailed description of the preferred embodiments, in association with the accompanying drawing figures.

### BRIEF DESCRIPTION OF THE DRAWINGS

The accompanying drawing figures incorporated in and forming a part of this specification illustrate several aspects of the invention, and together with the description serve to explain the principles of the invention.

FIG. 1 illustrates a conventional magnetostrictive probe positioned in a fuel storage tank;

FIG. 2 illustrates a probe according to a first sealed bladder embodiment of the present invention;

FIGS. 3A and 3B illustrate the bladder of FIG. 2 in a compressed and uncompressed state, respectively;

FIG. 4 illustrates a probe according to a second sealed bladder embodiment of the present invention;

FIGS. 5A and 5B illustrate the bladder of FIG. 4 in a compressed and uncompressed state, respectively;

FIG. 6 illustrates a probe according to an open bladder embodiment of the present invention; and

FIG. 7 illustrates a fueling environment that uses the probes of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The present invention is an improvement on a conventional fuel level probe adapted for use in a fuel storage tank. Specifically, the present invention adds a fuel weight sensor to the probe shaft of a magnetostrictive probe operating with a typical fuel float. The fuel weight sensor is, in practice, proximate the bottom of the probe shaft. The fuel weight sensor works to measure the weight of a column of fuel positioned above the fuel weight sensor. The fuel float together with the fuel weight sensor allows calculation of the volume of the column of fuel. The weight of the column of fuel divided by the volume of the column of fuel results in a density measurement for the column of fuel, from which the density of the fuel in the fuel storage tank may be inferred.

The fuel weight sensor includes a compressible portion that compresses or decompresses as a function of the weight of the fuel column. The fuel weight sensor also includes a magnet positioned on top of the compressible portion of the sensor. As the compressible portion of the sensor changes shape due to changes in the weight of the column of fuel, the magnet on top of the compressible portion of the sensor moves relative to the probe shaft of the magnetostrictive probe, and in particular moves relative the bottom of the probe shaft. The position of the magnet of the fuel weight sensor may be detected by the magnetostrictive probe. By comparing the position of the magnet of the fuel weight sensor to a position of the fuel float, a height of the column of fuel may be determined. By comparing the position of the magnet of the fuel weight sensor to a known reference point, the weight of the column of fuel may be determined. Using the height to calculate volume of the column of fuel, the weight may be divided by the volume, and the density derived.

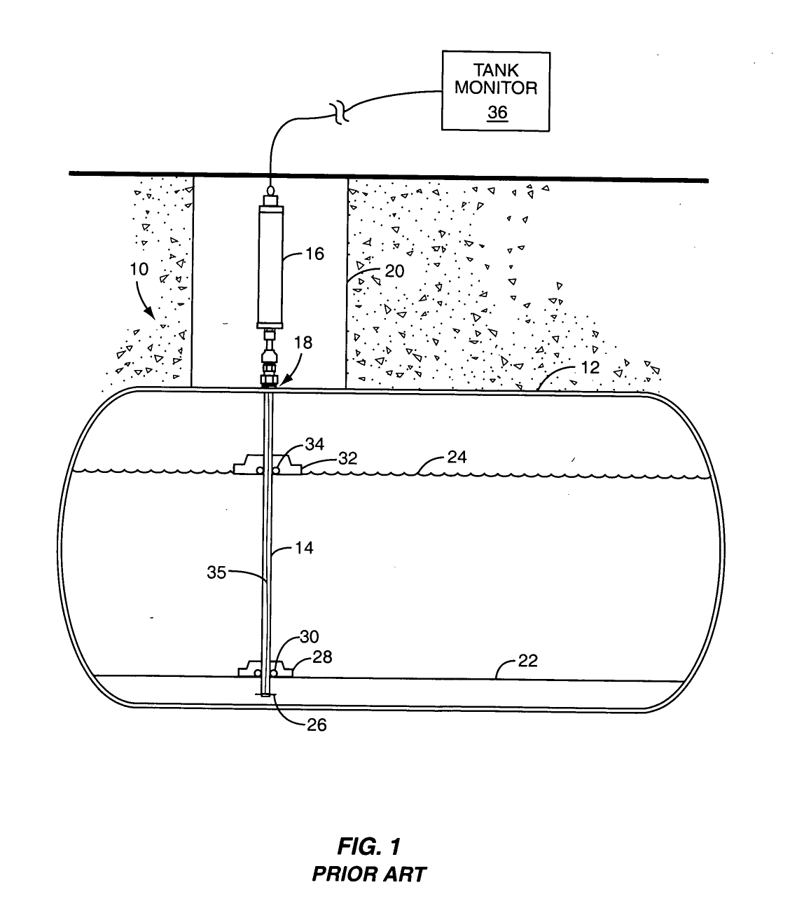

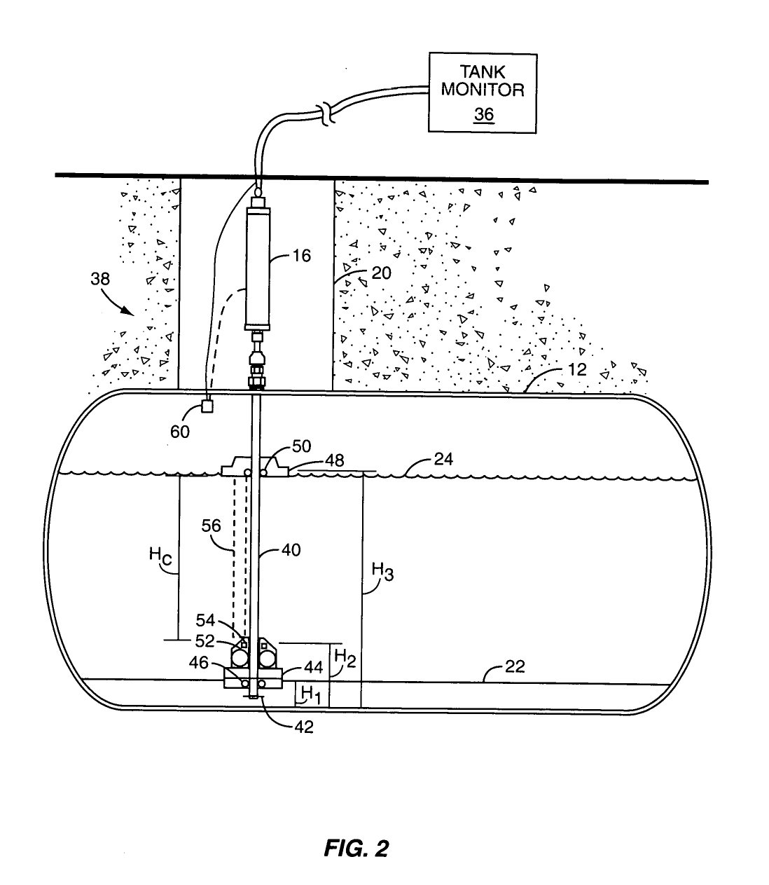

Because the present invention's calculation of fuel density requires knowledge of a volume of a column of fuel, and magnetostrictive probes measure heights of fuel within fuel storage tanks from which volumes of fuel within fuel storage tanks can be determined, a review of a conventional magnetostrictive probe is helpful. A conventional magnetostrictive probe 10 (hereinafter “probe”) is presented in FIG. 1. The discussion of the present invention begins with FIG. 2 below.

The probe 10 is a magnetostrictive probe such as the MAG PROBE™ magnetostrictive probe sold by the assignee of this patent application namely, Veeder-Root Company of 125 Powder Forest Drive, Simsbury, Conn. 06070 (see, for example, http://www.veeder.com/dynamic/index.cfm?PageID=103 and http://www.veeder.com/dynamic/index.cfm?PageID=274). The probe 10 is positioned partially in a fuel storage tank 12. Specifically, a probe shaft 14 extends into the fuel storage tank 12 while a canister 16 and attachment fittings 18 are positioned outside of the fuel storage tank 12, preferably within a sump 20 or some other secondary containment device.

In use, most fuel storage tanks, such as fuel storage tank 12, have a small amount of water therein. This water collects at the bottom of the fuel storage tank 12, forming a water-fuel interface 22. The fuel sits on top of the water and has an air-fuel interface 24 at the ullage of the fuel storage tank 12.

The probe shaft 14 has a reference magnet 26 positioned proximate a terminal end of the probe shaft 14. The reference magnet 26 may be positioned in a boot (not shown) that slips over the end of the probe shaft 14 as is conventional. A water level float 28, typically an annular float, is positioned on the probe shaft 14 and floats at the level of the water-fuel interface 22. A water level magnet 30 is associated with the water level float 28 so that the level of the water in the fuel storage tank 12 can be ascertained.

A fuel level float 32, also generally an annular float, is positioned on the probe shaft 14 and floats at the air-fuel interface 24. A fuel level magnet 34 is associated with the fuel level float 32 so that the level of the fuel in the fuel storage tank 12 can be ascertained. It should be appreciated that the floats 28 and 32 move freely up and down the probe shaft 14 as the respective levels of fluids (water and fuel) change. Likewise, the buoyancy of the floats 28 and 32 is determined by the fluid on which they will be floating. Such parameters are conventional and well understood by someone of ordinary skill in the art. However, the interested reader is directed to the MAG 1 & 2 PLUS! PROBES ASSEMBLY GUIDE, published by Veeder-Root, which is available online at http://vrnotesweb1.veeder.com/vrdocrep.nsf/Files/577013-764/$File/577013-744.pdf, and is submitted as part of an Information Disclosure Submission accompanying this application. The ASSEMBLY GUIDE is hereby incorporated by reference in its entirety.

To determine the fuel level and the water level within the fuel storage tank 12, the probe 10 sends an electric current down a magnetostrictive wire 35 in the probe shaft 14, and then detects torsional wave reflections induced by the magnets 30 and 34 of the floats 28 and 32 respectively. The torsional wave reflections are detected with a detector (not shown explicitly), typically positioned in the canister 16. The first reflection to arrive at the detector is a reflection from the fuel level magnet 34 associated with the fuel level float 32. The second reflection to arrive at the detector is a reflection from the water level magnet 30 associated with the water level float 28. A third reflection is derived from the reference magnet 26. Since the speed of the torsional wave in the magnetostrictive wire 35 is known (typically about 3000 m/s), it is possible to calculate the distance between the detector and the magnet that induced the torsional wave. The detector thus measures the time elapsed between the origination of the pulse and the arrival of each torsional wave reflection. If the distance from the detector to a particular magnet is known, it is a well known exercise to determine the level of that particular magnet within the fuel storage tank 12. Put another way, the heights of the magnets relative to the bottom of the fuel storage tank 12 are determinable.

The probe 10 reports the measured reflections to a tank monitor 36, such as the TLS-350R manufactured and sold by the Veeder-Root Company. The tank monitor 36 uses the data from the probe 10, and specifically, the measured reflections to determine the volume of fuel within the fuel storage tank 12. For example, the tank monitor 36 may determine a volume of fuel within the fuel storage tank 12 by subtracting the height of the water, as determined by the height of the water level float 28 (and as measured by the second reflection), from the height of the fuel level, as determined by the height of the fuel level float 32 (and as measured by the first reflection). From this calculation, a conventional tank strapping algorithm or other conventional technique may be applied, as is well understood in the art, to arrive at the volume of fuel within the fuel storage tank 12.

The present invention adds another sensor to the probe 10, resulting in a probe 38 illustrated in FIG. 2. The probe 38 facilitates calculation of a weight of a column of fuel, and from the calculated weight, a calculated density for the fuel within the fuel storage tank 12. The probe 38 is associated with the fuel storage tank 12 in the same manner as conventional probe 10. A probe shaft 40 extends into the fuel storage tank 12, and has a reference magnet 42 positioned proximate a terminal end of the probe shaft 40. A water level float 44, such as an annular float, is positioned on the probe shaft 40, and floats at the level of the water-fuel interface 22. A water level magnet 46 is associated with the water level float 44 so that the water level in the fuel storage tank 12 can be ascertained. A fuel level float 48, also generally annular, is positioned on the probe shaft 40, and floats at the air-fuel interface 24. A fuel level magnet 50 is associated with the fuel level float 48 so that the fuel level in the fuel storage tank 12 can be ascertained. The volume of the fuel for the fuel storage tank 12 is determined using the difference in heights of the fuel and tank levels as explained above.

A pressure sensor 60 may also be present within the fuel storage tank 12. The pressure sensor 60 may sense the ambient pressure (p) within the fuel storage tank 12. The pressure sensor 60 may be conventional, and may be the Model 201 Pressure Transducer sold by SETRA of 159 Swanson Road, Boxborough, Mass. 01719-1304. More information about SETRA sensors, including the Model 201 Pressure Transducer, can be found online at http://www.setra.com. The pressure sensor 60 reports its data to the probe 38, the tank monitor 36, or other location as needed or desired depending on where the calculations of the present invention are performed.

The present invention lies in the addition of a fuel weight sensor to, the probe 38. The fuel weight sensor is designed to weigh a portion of the fuel within the fuel storage tank 12. In the abstract, the new fuel weight sensor may more appropriately be called a pressure sensor. However, to help avoid confusion with the pressure sensor 60 that measures the pressure of the air within the fuel storage tank 12, the present disclosure will refer to the new sensor as a fuel weight sensor. The fuel weight sensor includes a deformable bladder 52 and a fuel weight magnet 54. The fuel weight magnet 54 is just a permanent magnet, but to differentiate fuel weight magnet 54 from the other magnets described herein, it will be referred to herein as the fuel weight magnet 54.

In the embodiment of FIG. 2, the deformable bladder 52 comprises a toroid shaped bladder, with the fuel weight magnet 54 positioned on the top of the deformable bladder 52. The deformable bladder 52 is positioned on a top surface of the water level float 44, and may be secured to a cradle that is secured to the top surface of the water level float 44. The fuel weight magnet 54 may be secured to a top side of the deformable bladder 52 by any conventional means, and may be formed within an annular top element that, together with the cradle, sandwich the deformable bladder 52. By positioning the fuel weight sensor on top of the water level float 44, this embodiment ensures that the fuel weight sensor is positioned completely within the fuel, rather than in the water within the fuel storage tank 12. By positioning the deformable bladder 52 completely within the fuel, water is not pressing on the deformable bladder 52, and thus, the deformable bladder 52 is weighing primarily fuel, along with a negligible amount of air.

The deformable bladder 52 may be formed from a material such as a fluorocarbon polymer so that the deformable bladder 52 can survive in the petroleum environment within the fuel storage tank 12. The deformable bladder 52 is filled to a normal pressure (such as 15 PSI) with a gas, such as air for example. Other inert gases may be used, such as nitrogen, if needed or desired. Likewise, the cradle and annular top element that sandwich the deformable bladder 52 may be made of any appropriate rigid material that can withstand the environment within the fuel storage tank 12.

The deformable bladder 52 moves with the water level float 44 up and down the probe shaft 40 depending on the level of water within the fuel storage tank 12. A column is positioned over the deformable bladder 52. This column may be conceived of as a column of air and a column of fuel 56. Both portions of the column weigh on the deformable bladder, although the weight of the column of air is negligible, especially in comparison to the weight of the column of fuel 56. The weight of the column causes the deformable bladder 52 to compress. By measuring the compression of the deformable bladder 52, a measured weight for the column of fuel may be determined, as better explained below. As noted above, by positioning the deformable bladder 52 on top of the water level float 44, the arrangement keeps the deformable bladder 52 within the fuel such that the column of fuel 56 is composed only of fuel and has no water therein. Since the water level float 44 floats at the water-fuel interface 22, the top of the water level float 44 should always be on the fuel side of the water-fuel interface 22 and the deformable bladder 52 should always be in the fuel. Other arrangements may also be used, which do not specifically affix the deformable bladder 52 to the top of the water level float 44, but it is preferred for ease of calculations that the deformable bladder 52 be positioned at least substantially above the water-fuel interface 22.

The column of fuel 56 has a weight that presses down on the deformable bladder 52 and causes the deformable bladder 52 to compress. The weight of the column of fuel 56 is a function of several factors. One factor is the volume of the column of fuel 56. The larger the volume, the more the column of fuel 56 weighs. A second factor is the density of the fuel within the column of fuel 56. The denser the fuel, the more the column of fuel 56 weighs. The amount that the deformable bladder 52 compresses also depends in part on the difference between the unloaded pressure of the inert gas within the deformable bladder 52 and the pressure outside (i.e., the pressure in the tank ullage space). This difference acts to bias the fuel weight sensor, adversely affecting its accuracy. For example, if the ullage pressure was much less than the pressure within the deformable bladder 52, the fuel weight sensor would be negatively biased, resulting in fuel weight estimates which were less than the true value. If the ullage pressure were much greater than the pressure within the deformable bladder 52, the bias and the effect would be reversed. The present invention compensates for this difference by using the pressure sensor 60 to report the ullage pressure, which in turn is compared to the known pressure within the deformable bladder 52 as is better explained below.

The present invention weighs the column of fuel 56 to arrive at a measured weight, and concurrently calculates, with software, an estimate of the weight bias. The estimate of the weight bias may be conceptualized as ƒ(ullage pressure p, unloaded bladder pressure). It should be appreciated that the ullage pressure p is reported by the pressure sensor 60 and the unloaded bladder pressure is known at the time of manufacture. Likewise, the function relating these two pressures may be obtained empirically and implemented as a look-up table or the like. The software then calculates an estimated true fuel weight by subtracting the estimated weight bias from the measured weight (measured weight−estimate of weight bias) and divides the estimated true fuel weight by the volume of the column of fuel 56 to estimate the density of the column of fuel 56. From the density of the column of fuel 56, the density of the fuel within the fuel storage tank 12 may be inferred. If this density is outside of predetermined parameters, it may be inferred that the fuel within the fuel storage tank 12 has been adulterated.

The deformable bladder 52 measures the weight of the column of fuel 56. Because the weight of the column of air is negligible, for the purposes of illustration, it will be ignored for the moment. Specifically, the more weight within the column of fuel 56, the more the deformable bladder 52 compresses. Conversely, the less weight within the column of fuel 56, the less the deformable bladder 52 compresses. The present invention weighs the column of fuel 56 by measuring the change in shape of the deformable bladder 52. Because the deformable bladder 52 moves with the water level float 44, to calculate how much the deformable bladder 52 is compressed, the position of water level float 44 is required. The water level magnet 46 provides an appropriate reference point to determine the position of the water level float 44.

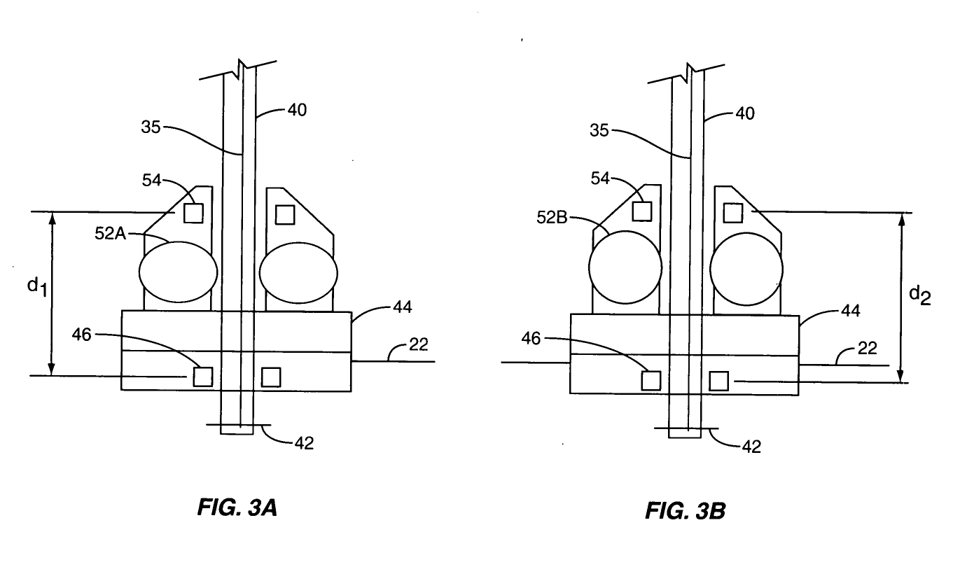

The changes in the shape of the deformable bladder 52 are better illustrated in FIGS. 3A and 3B. Specifically, in FIG. 3A, the weight of the column of fuel 56 is relatively large, and has compressed the deformable bladder 52 into a compressed bladder 52A. Conversely, in FIG. 3B, the weight of the column of fuel 56 is relatively small and has allowed the deformable bladder 52 to decompress to decompressed bladder 52B. To determine how compressed the deformable bladder 52 is, reference to water level magnet 46 is made and more particularly, the distance between the fuel weight magnet 54 and the water level magnet 46 is measured. For example, in FIG. 3A, when the deformable bladder 52 is compressed into compressed bladder 52A, the distance between the fuel weight magnet 54 and the water level magnet 46, labeled “d₁”, is relatively small. Conversely, in FIG. 3B, when the deformable bladder 52 has expanded into decompressed bladder 52B, the distance between fuel weight magnet 54 and the water level magnet 46, labeled “d₂”, is relatively large, or at a minimum, not reduced. Note that in either case, both d₁ and d₂ both are equal to (H₂−H₁) (See FIG. 2). As noted above, a compressed bladder 52A is indicative of a comparatively large weight for the column of fuel 56 and a decompressed bladder 52B is indicative of a comparatively small weight for the column of fuel 56. As further noted above, for a given volume of fuel within the column of fuel 56, changes in the weight of the column of fuel 56 represent changes in the density of the column of fuel 56, and thus by measuring the distance between the fuel weight magnet 54 and the water level magnet 46, the density of the column of fuel 56 may be determined.

While the math to calculate the density of the column of fuel 56 has been alluded to above, a more robust presentation of the formulas involved is presented. As noted above, density (D) is a function of weight (W) and volume (V). Specifically:
D=W/V

In the present invention, the column of fuel 56 has a weight (W_{f}) (corresponding to the estimated true weight described above) and a volume (V_{f}), and the density of the column of fuel 56 (D_{f}) equation is:
D_{f}=W_{f}/V_{f}

To determine the volume of the column of fuel 56, it is relevant to note that the column of fuel 56 has a cross sectional area (A_{C}) and a height (H_{C}). In other words:
V_{f}=A_{B}*H_{C}

To determine H_{C}, reference is made to FIG. 2, wherein the height of the water level magnet 46 relative to the bottom of the fuel storage tank 12 may be conceptualized as H₁; the height of the fuel weight magnet 54 relative to the bottom of the fuel storage tank 12 may be conceptualized as H₂; and the height of the fuel level magnet 50 relative to the bottom of the fuel storage tank 12 may be conceptualized as H₃. By design H_{C} is approximately equal to (H₃−H₂). Thus:
V_{f}≈A_{B}*(H₃−H₂)

The weight (W_{f}) of the column of fuel 56 is a function of the distance between the fuel weight magnet 54 and the water level magnet 46. Substituting this function into the general equation causes this function to be:
W_{f}=ƒ(H₂−H₁)
If the formulas for W_{f} and V_{f} are plugged back into the original equation:
D_{f}≈ƒ(H₂−H₁)/{A_{B}*(H₃−H₂)}

In use, the probe 38 generates an electric current down the magnetostrictive wire 35 of the probe shaft 40 and measures the time delay for each reflection to arrive. The first reflection comes from the fuel level magnet 50; the second reflection comes from the fuel weight magnet 54; the third reflection comes from the water level magnet 46; and the last reflection comes from the reference magnet 42. If the time delay is divided by two and the speed of the pulse applied, the distance to the magnet generating the reflection can be determined. From these distance measurements, H₁, H₂, and H₃ can be derived. When the reflection from the reference magnet 42 arrives, the probe 38 stops the measuring and reports the results back to the tank monitor 36. The probe 38 or the tank monitor 36 may calculate the respective heights of the magnets 50, 54, and 46 and then calculate the fuel density according to the formulas outlined above.

It should be appreciated that the function that calculates W_{f} may be linear or non-linear. Further, it is expected that the function may be derived empirically and stored in a look up table or the like.

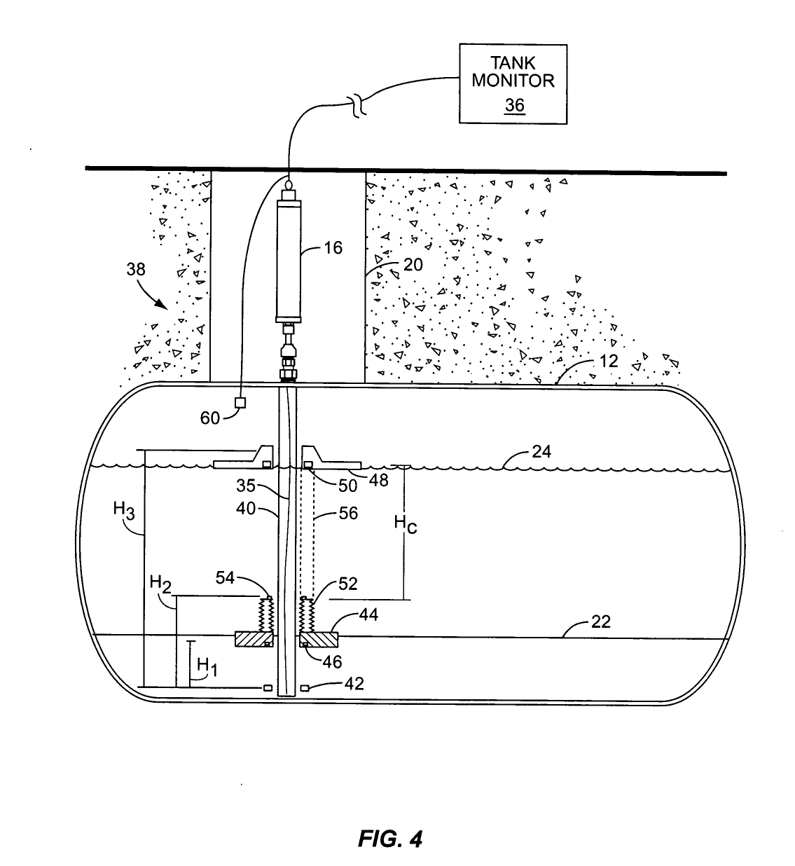

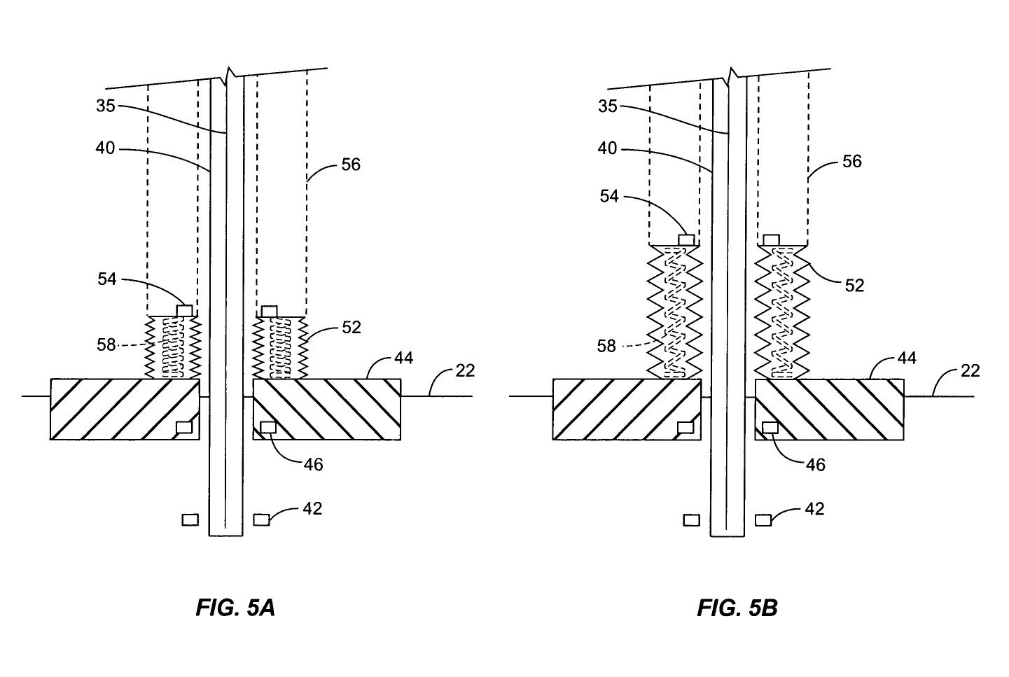

FIG. 4 illustrates an alternate embodiment of the present invention. In this embodiment, the deformable bladder 52 is shaped like a bellows, and may include an internal spring 58 (FIGS. 5A, 5B) (shown by dashed lines). This arrangement makes ƒ(H₂−H₁) more linear, but may still use an empirically derived look up table or the like. Likewise, the pressure may cause ƒ(p, H₂−H₁) to be less linear. In all other aspects, the embodiment of FIG. 4 matches the embodiments of FIGS. 2, 3A, and 3B. While two bellows are shown in FIG. 4, it should be appreciated that the bellows could be a single bellows positioned on a small portion of the water level float 44, an annularly shaped bellows that surrounds the probe shaft 40, or other arrangement as needed or desired. Such alternate arrangements may change the cross sectional area of the deformable bladder 52, but do not implicate the inventive concepts of the present invention.

FIGS. 5A and 5B correspond to FIGS. 3A and 3B, and show a compressed bladder 52A (FIG. 5A) and an expanded bladder 52B (FIG. 5B).

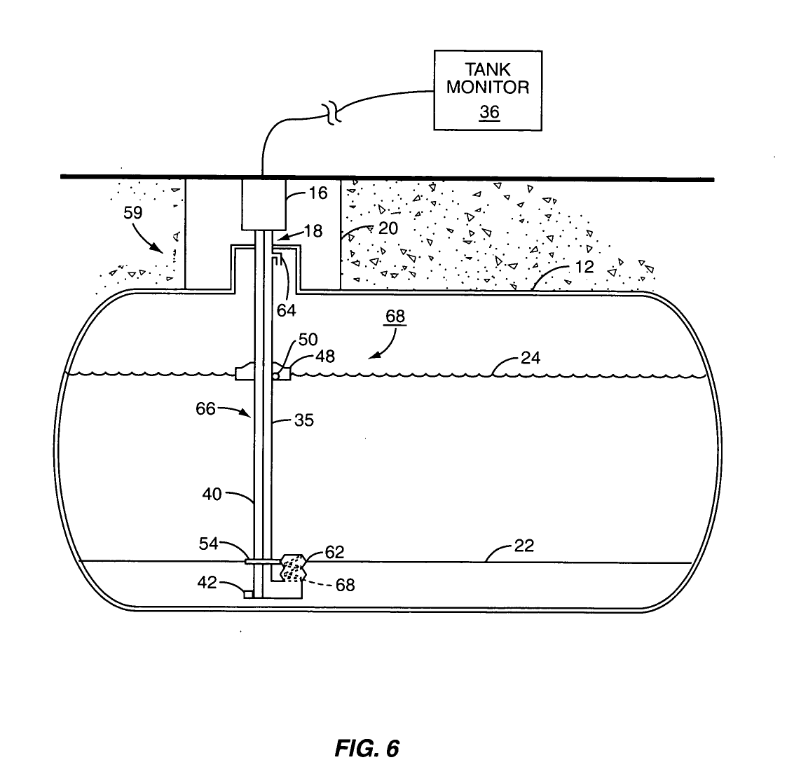

FIG. 6 illustrates another alternate embodiment of the present invention, namely probe 59. In this embodiment, the fuel storage tank 12 does not have a pressure sensor 60, because the deformable bladder 52, embodied as a bellows 62 is fluidly coupled to the ambient pressure within the fuel storage tank 12 via a vent or opening 64 within the probe shaft 40. The opening 64 connects to the bellows 62 through a hollow portion 66 of the probe shaft 40. The bellows 62 may have a spring 68 positioned therein. As the density of the fuel changes, the bellows 62 expands and contracts in the same manner as the bellows shaped deformable bladder 52 as described above with respect to FIGS. 4, 5A, and 5B, raising and lowering the fuel weight magnet 54 on the shaft of the probe shaft 40. That is, the fuel weight magnet 54 may be an annulus that surrounds the probe shaft 40 and traverses up and down on the probe shaft 40 as the bellows 62 expands and contracts by virtue of the fuel weight magnet 54 being attached to the top part of the bellows 62. In this embodiment, the water level float 44 may be omitted so that it does not interfere with the movement of the bellows 62. The probe 59 does not measure the water level and stops “listening” for a reflection after the third reflection (corresponding to the reflection from the reference magnet 42) arrives. Probe 59 reports the measurements to the tank monitor 36 as previously described. Instead of subtracting the height of the water level float 44 to arrive at the current size of the bellows 62, the known height of the bottom of the bellows 62 is subtracted. While this embodiment is functional, it does have the possibility that the bellows 62 will compress such that the column of fuel 56 will have a water component that is positioned over the fuel weight magnet 54.

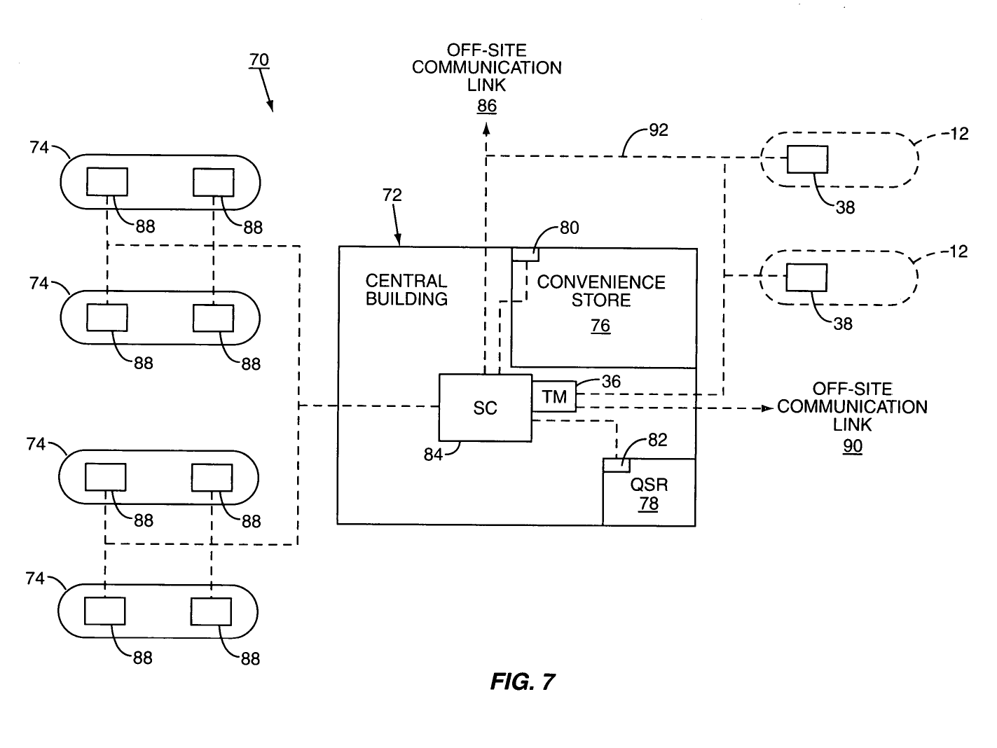

FIG. 7 illustrates a fueling environment that may incorporate the present invention, and includes the systems and devices that calculate and/or communicate the density of the fuel in the fuel storage tank 12. Specifically, the fueling environment 70 may comprise a central building 72 and a plurality of fueling islands 74.

The central building 72 need not be centrally located within the fueling environment 70, but rather is the focus of the fueling environment 70, and may house a convenience store 76 and/or a quick serve restaurant 78 therein. Both the convenience store 76 and the quick serve restaurant 78 may include a point of sale 80, 82 respectively. The central building 72 may further house a site controller (SC) 84, which in an exemplary embodiment may be the G-SITE® POS sold by Gilbarco Inc. of Greensboro, N.C. The site controller 84 may control the authorization of fueling transactions and other conventional activities, as is well understood. The site controller 84 may be incorporated into a point of sale, such as point of sale 80, if needed or desired. Further, the site controller 84 may have an off-site communication link 86 allowing communication with a remote location for credit/debit card authorization, content provision, reporting purposes, or the like, as needed or desired. The off-site communication link 86 may be routed through the Public Switched Telephone Network (PSTN), the Internet, both, or the like, as needed or desired.

The plurality of fueling islands 74 may have one or more fuel dispensers 88 positioned thereon. The fuel dispensers 88 may be, for example, the ECLIPSE® dispenser or the ENCORE® dispenser sold by Gilbarco Inc. of Greensboro, N.C. The fuel dispensers 88 are in electronic communication with the site controller 84 through a LAN or the like.

The fueling environment 70 has one or more fuel storage tanks 12 adapted to hold fuel therein. In a typical installation, fuel storage tanks 12 are positioned underground, and may also be referred to as underground storage tanks. Further, each fuel storage tank 12 has a liquid level probe, such as probes 38. The probes 38 report to the tank monitor (TM) 36 associated therewith. Reporting to the tank monitor 36 may be done through a wire-based system, such as a LAN, or a wireless system, as needed or desired. The tank monitor 36 may communicate with the fuel dispensers 88 (either through the site controller 84 or directly, as needed or desired) to determine amounts of fuel dispensed, and compare fuel dispensed to current levels of fuel within the fuel storage tanks 12, as needed or desired. In a typical installation, the tank monitor 36 is also positioned in the central building 72, and may be proximate the site controller 84.

The tank monitor 36 may communicate with the site controller 84, and further may have an off-site communication link 90 for leak detection reporting, inventory reporting, or the like. Much like the off-site communication link 86, off-site communication link 90 may be through the PSTN, the Internet, both, or the like. If the off-site communication link 90 is present, the off-site communication link 86 need not be present, although both links may be present if needed or desired. As used herein, the tank monitor 36 and the site controller 84 are site communicators to the extent that they allow off-site communication and report site data to a remote location.

The present invention capitalizes on the off-site communication link 90 by forwarding data from the probe 38 to the remote location. This data should preferably be protected from tampering such that the site operator cannot alter the data sent to the remote location through any of the off-site communication links. This tamper proof flow of data is provided so that the site operator, who presumably is the one who might be inclined to adulterate the fuel, does not have access to the data that reports on whether the fuel has been adulterated. The data from the probes 38 may be provided to a corporate entity from whom the site operator has a franchise, a governmental monitoring agency, an independent monitoring agency, or the like, as needed or desired. One way to prevent tampering is through an encryption algorithm.

An alternate technique that helps reduce the likelihood of tampering is the use of a dedicated off-site communication link 92, wherein the probes 38 report directly to a location removed from the fueling environment 70. In this manner, the operator of the fueling environment 70 does not have ready access to the dedicated off-site communication link 92.

For further information on how elements of a fueling environment 70 may interact, reference is made to U.S. Pat. No. 5,956,259, which is hereby incorporated by reference in its entirety. Information about fuel dispensers may be found in U.S. Pat. Nos. 5,734,851 and 6,052,629, which are hereby incorporated by reference in their entirety. For more information about tank monitors 36 and their operation, reference is made to U.S. Pat. Nos. 5,423,457; 5,400,253; 5,319,545; and 4,977,528, which are hereby incorporated by reference in their entireties.

It should be appreciated that bladders may be formed of different materials, and be of different shapes, and still fall within the scope of the present invention. For example, it may be possible to formulate a solid compressible bladder capable of changing shape in the same manner as described above. Likewise, while it is preferred that the fuel weight magnet 54 be generally positioned proximate the bottom of the fuel storage tank 12 so as to weigh a larger column of fuel, some other positioning on the probe shaft 40 of the magnetostrictive probe may also be effectuated if needed or desired. However, the larger the column of fuel 56 being weighed, the greater the likelihood that any variations within the fuel (created by temperature variations or other factors) are averaged out, such that there are no fewer false positives.

Those skilled in the art will recognize improvements and modifications to the preferred embodiments of the present invention. All such improvements and modifications are considered within the scope of the concepts disclosed herein and the claims that follow.

What is claimed is:

1. A fuel level probe, comprising:
a probe shaft adapted to be positioned in a fuel tank; and
a fuel weight sensor comprising a deformable bladder, said fuel weight sensor positioned proximate said probe shaft and adapted to sense fuel density within the fuel tank and report data thereabout to a remote location.

2. The fuel level probe of claim 1, further comprising a fuel level float adapted to float at a top surface of fuel within the fuel tank and provide an indication of a fuel level within the fuel tank for the fuel level probe.

3. The fuel level probe of claim 1, further comprising a water level float adapted to float at a level proximate a water-fuel interface within the fuel tank and further adapted to provide an indication of a water level within the fuel tank for the fuel level probe.

4. The fuel level probe of claim 3, wherein said fuel weight sensor is positioned on top of said water level float proximate a bottom of the fuel tank.

5. The fuel level probe of claim 1, wherein said deformable bladder comprises a toroid shaped bladder.

6. The fuel level probe of claim 1, wherein said deformable bladder comprises a compressible bellows.

7. The fuel level probe of claim 1, wherein said fuel weight sensor comprises a magnet adapted to cause a reflection such that a time measurement of the reflection may be used to determine a height of the magnet relative to the probe shaft.

8. The fuel level probe of claim 6, wherein said deformable bladder is positioned on a terminal end of said probe shaft proximate a bottom of the fuel tank.

9. The fuel level probe of claim 6, wherein said probe shaft delimits an opening positioned above a fuel level within the fuel tank, said opening fluidly coupled to said compressible bellows such that gaseous material within said compressible bellows is at an ambient pressure.

10. The fuel level probe of claim 1, further comprising a pressure sensor adapted to report ambient pressure levels within the fuel tank for use by the fuel level probe in determining current fuel density associated with fuel within the fuel tank.

11. A method of detecting fuel density for fuel within a fuel storage tank, comprising:
weighing a column of fuel within the fuel storage tank to arrive at a weight of the column of fuel with a sensor associated with a fuel level probe, wherein said weighing the column of fuel comprises weighing with a compressible bladder;
determining a volume for the column of fuel; and
dividing the weight of the column of fuel by the volume to arrive at a fuel density level; and
reporting the fuel density level to a location removed from the fuel level probe.

12. The method of claim 11, wherein weighing the column of fuel with a compressible bladder comprises using a compressible bladder whose shape changes as a function of the weight of the column of fuel.

13. The method of claim 12, wherein using a compressible bladder comprises using a bellows.

14. The method of claim 12, wherein weighing a column of fuel comprises, at least in part, measuring a time component associated with a torsional reflection.

15. The method of claim 11, wherein weighing a column of fuel comprises compensating for ullage pressure within the fuel storage tank.

16. The method of claim 15, wherein compensating for pressure within the fuel storage tank comprises detecting an ambient ullage pressure in the fuel storage tank.

17. The method of claim 15, wherein compensating for pressure within the fuel storage tank comprises fluidly coupling the compressible bladder to an ambient pressure within the fuel storage tank.

18. The method of claim 11, wherein determining a volume for the column of fuel comprises measuring a fuel depth with a magnetostrictive probe.

19. The method of claim 12, wherein using a compressible bladder comprises positioning the compressible bladder on a water-fuel level float proximate a bottom of the fuel storage tank.

20. The method of claim 11, wherein reporting the fuel density to a location removed from the fuel level probe comprises encrypting data from the fuel level probe such that it cannot be altered by a fueling site operator.

21. The method of claim 11, wherein determining a volume for the column of fuel comprises using a known cross sectional area (A_{C}) of the compressible bladder.

22. The method of claim 21, wherein determining a volume for the column of fuel further comprises determining a height (H_{C}) of the column of fuel.

23. The method of claim 22, wherein determining a volume for the column of fuel further comprises multiplying the height (H_{C}) of the column of fuel by the known cross sectional area (A_{C}) of the compressible bladder (A_{C}*H_{C}).

24. The method of claim 23, wherein weighing a column of fuel within the fuel storage tank comprises determining a distance between a magnet associated with a top of the compressible bladder and a magnet associated with a water level float.

25. The method of claim 24, further comprising empirically determining a function that correlates the weight to the distance.

26. A system of measuring fuel density in a fuel storage tank, comprising:
a magnetostrictive fuel level probe adapted to determine a fuel level within the fuel storage tank, said magnetostrictive fuel level probe comprising a probe shaft adapted to extend into the fuel storage tank;
a fuel weight sensor positioned proximate said probe shaft and adapted to weigh a column of fuel within the fuel storage tank; and
a control system adapted to determine the fuel density from the weight of the column of fuel and the fuel level within the fuel storage tank.

27. The system of claim 26, wherein fuel weight sensor comprises a deformable bladder.

28. The system of claim 27, wherein the deformable bladder comprises a bellows.

29. The system of claim 27, wherein the deformable bladder comprises a toroid shaped bladder.

30. The system of claim 27, wherein the fuel weight sensor further comprises a magnet positioned atop the deformable bladder, the magnet adapted to reflect an electromagnetic signal created by the magnetostrictive fuel level probe such that a time measurement of the reflected electromagnetic signal may be used to determine a height of the magnet relative to the probe shaft.

31. The system of claim 27, wherein the magnetostrictive fuel level probe is adapted to determine a fuel level within the fuel storage tank with a fuel level float and is further adapted to determine a water level within the fuel storage tank with a water level float.

32. The system of claim 31, wherein the fuel weight sensor is positioned atop the water level float.

33. The system of claim 26, wherein the fuel weight sensor is positioned on a terminal end of the probe shaft and extending to the side thereof.

34. The system of claim 33, wherein the fuel weight sensor comprises a deformable bellows.

35. The system of claim 33, wherein the probe shaft delimits an opening positioned above the fuel level within the fuel storage tank, said opening fluidly coupled to the deformable bellows such that gaseous material within the deformable bellows is at an ambient pressure.

36. The system of claim 26, further comprising a pressure sensor adapted to report pressure readings to the control system.

37. The system of claim 26, wherein the control system is adapted to determine the fuel density from the weight of the column of fuel and the fuel level within the fuel storage tank by using the fuel level to help determine a volume of the column of fuel.

38. The system of claim 37, wherein the control system is adapted to determine the fuel density by dividing the weight of the column of fuel by the volume of the column of fuel.

39. The system of claim 38, wherein the control system is adapted to determine the fuel density by compensating for pressure within the fuel storage tank.

40. The system of claim 26, wherein the control system is adapted to report the fuel density to an off-site location directly.

41. The system of claim 26, wherein the control system is adapted to report the fuel density to an off-site location indirectly through a site communicator.

42. The system of claim 26, further comprising a tank monitor and said control system is associated with the tank monitor.

43. The system of 26, wherein the control system is adapted to report the fuel density to an off-site location in an encrypted format.

44. The system of claim 26, wherein the control system is adapted to determine a distance between a magnet on a water float and a magnet associated with the fuel weight sensor.

45. The system of claim 44, wherein the control system uses the distance between the magnet on the water float and the magnet associated with the fuel weight sensor to weigh the column of fuel.

46. The system of claim 26, wherein said fuel weight sensor is positioned proximate a bottom of the fuel storage tank.

47. The system of claim 26, wherein said control system is adapted to determine the fuel density from the weight of the column of fuel and the fuel level within the fuel storage tank by:
weighing a column of fuel within the fuel storage tank to arrive at a weight of the column of fuel with a sensor associated with a fuel level probe, wherein said weighing the column of fuel comprises weighing with a compressible bladder;
determining a volume for the column of fuel; and
dividing the weight of the column of fuel by the volume to arrive at a fuel density level; and
reporting the fuel density level to a location removed from the fuel level probe.

48. The system of claim 47, wherein the control system is further adapted to determine a volume for the column of fuel by using a known cross sectional area (A_{C}) of the compressible bladder.

49. The system of claim 48, wherein the control system is further adapted to determine a volume for the column of fuel further by determining a height (H_{C}) of the column of fuel.

50. The system of claim 48, wherein the control system is further adapted to determine a volume for the column of fuel further by multiplying the height (H_{C}) of the column of fuel by the known cross sectional area (A_{C}) of the compressible bladder (A_{C}*H_{C}).
